(19) United States
(12) Patent Application Publication
(10) Pub. No.: US 2025/0377885 A1
(43) Pub. Date: Dec. 11, 2025

(54) OPERATING SYSTEM LIVE UPDATE IN A RESOURCE CONSTRAINED SYSTEM

(71) Applicant: INTERNATIONAL BUSINESS MACHINES CORPORATION, ARMONK, NY (US)

(72) Inventors: Shivarudrappa Satyanaik, Bangalore (IN); Himanshu Shrivastava, Vidisha (IN); Sanket Rathi, Hyderabad (IN); Naresh Bannoth, Sangareddy (IN)

(21) Appl. No.: 18/739,577

(22) Filed: Jun. 11, 2024

(51) Int. Cl. G06F 8/656; G06F 9/455; G06F 9/48; G06F 9/50

(52) U.S. Cl. CPC G06F 8/656; G06F 9/45558; G06F 9/4856; G06F 9/5077; G06F 2009/45562; G06F 2009/45575; G06F 2209/485; G06F 2209/503; G06F 2209/506

(57) ABSTRACT

A method, computer system, and computer program product are provided to perform operating system live update in a resource constrained computer system. A computer system orchestrator verifies that contents of a profile definition of each virtual machine (VM) includes a valid assigned priority. Orchestrator verifies sufficient free resources are available in the computer system to create a new VM corresponding to an original VM. Based on there not being sufficient free resources, beginning with a donor VM having a lowest priority and continuing to the donor VM having a next higher priority, moving resources from the donor VM to the new VM until the new VM has resources corresponding to the original VM. Updating software on the original VM. Exporting the root volume group to a new VM that is activated using the updated root volume group. The workload is non-disruptively migrated from the original VM to the new VM.

### BACKGROUND

The present invention relates generally to the field of computing, and more particularly to live update of operating system software in a resource constrained system.

Customers running business-critical workloads cannot tolerate downtime, even though the downtime may be needed to apply necessary software updates. Technology, referred to as live update or non-disruptive update, exists to update software on running systems. However, if the running system does not have sufficient available resources, either the live update will not execute, or it may fail in progress thereby requiring a recovery.

It would be advantageous to successfully complete a live update of a running system, even in a resource constrained system, thereby avoiding downtime of business-critical workloads.

### SUMMARY

Embodiments of the present invention disclose a computer-implemented method, computer system, and a computer program product are provided to perform operating system live update in a resource constrained computer system. A computer system orchestrator verifies that contents of a profile definition of each virtual machine (VM) includes a valid assigned priority. Orchestrator verifies sufficient free resources are available in the computer system to create a new VM corresponding to an original VM. Based on there not being sufficient free resources, beginning with a donor VM having a lowest priority and continuing to the donor VM having a next higher priority, moving resources from the donor VM to the new VM until the new VM has resources corresponding to the original VM. Updating software on the original VM. Exporting the root volume group to a new VM that is activated using the updated root volume group. The workload is non-disruptively migrated from the original VM to the new VM.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of an operating environment before and after a live update according to at least one embodiment; and

FIG. 3 is an operational flowchart illustrating a live update operation according to at least one embodiment.

### DETAILED DESCRIPTION

The following described exemplary embodiments provide a computer system, computer-implemented method, and computer program product for live update of operating system software in a resource constrained system.

Enterprise computer installations typically host business-critical workloads that require continuous or near-continuous uptime. Additionally, to maximize their return on investment in technology, minimize the requirement for computer room floor space, and reduce power consumption, customers tend to select physical computers that can be configured as multiple virtual environments, referred to as virtual machines (VM).

However, this highly concentrated computing environment is challenging to administer, particularly when installing and updating the operating system (OS) software, here referred to generically as maintenance, is needed and downtime cannot be scheduled. Some architectures provide a live update facility, either as part of their OS or as a separate utility. While these facilities enable simultaneous or near simultaneous distribution and application of maintenance, the computers still need to be restarted to have the maintenance take effect. Additionally, if the VM that will be updated does not have enough available resources, such as CPU, memory, and disk space, either the live update is not performed, or it will fail, requiring a rollback and recovery of the affected OS.

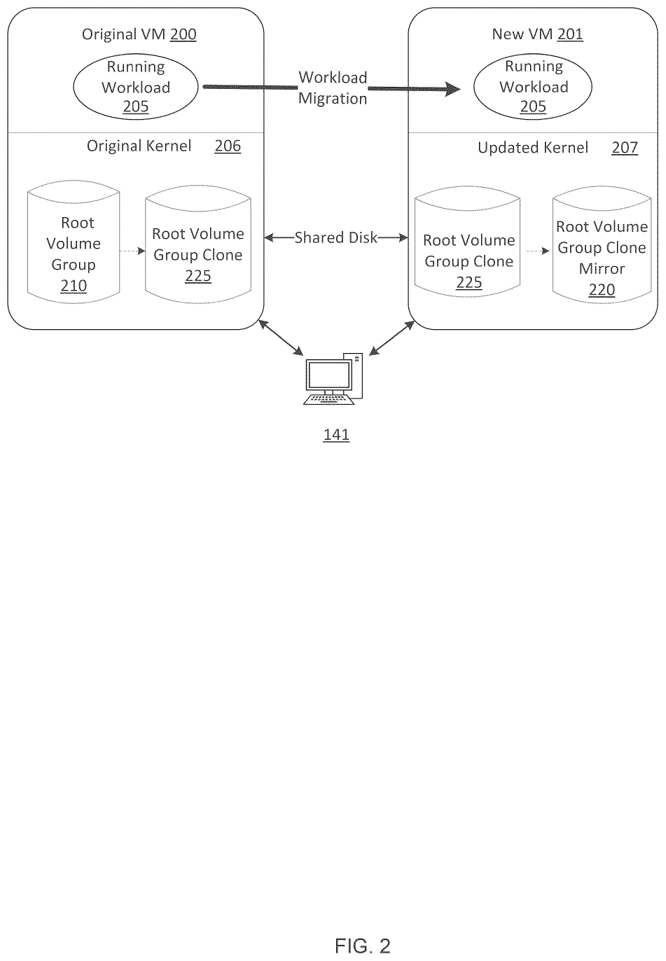

The general live update concept is shown in FIG. 2. For the live update process occurring on the same system (local), an administrative computer creates a surrogate VM that has the same characteristics, e.g., storage, CPU, memory, as the original VM. The root volume group of the surrogate VM is a cloned image of the original root volume group, including the software updates. After the updated surrogate VM boots, the workload is migrated from original VM to the surrogate VM and then original VM is deleted. The surrogate VM must have the same resources as the original VM to ensure a successful update. If the required resources are not available within the system to create surrogate, the VM live update fails.

Alternatively, if the local system does not have the resources for the live update, the live update can be scheduled on a different system (remote). In this case, the VM to be updated is migrated to the remote system. After successful completion, the VM is migrated back to the original system. This method requires more planning, and two additional migration operations, thereby incurring more overhead.

Embodiments of the present invention address these shortcomings by enabling live update of software to occur without stopping running workloads or restarting the computers, particularly in a resource constrained system. Live update is particularly useful when the software includes updates to the operating system kernel since a kernel update is considered disruptive because it requires a computer reboot.

These embodiments are particularly applicable to computer architectures that support a dynamic logical partitioning feature. Creating the new VM that is the live update target requires moving and reallocating resources from elsewhere in the computer. Dynamic logical partitioning reduces the need for systems administrator action, especially when updating software on many VMs. However, embodiments of the present invention can be practiced manually.

Although presented in the context of the AIX® OS, these embodiments may be added to other architectures that support virtual machines, remote management, shared disk storage, and software repositories. AIX® is a registered trademark of IBM Corp., in the US or other countries or both.

In the embodiments of the present invention, the administrators of the systems in the enterprise computer installations set the priorities of the various VMs. The priority is set in the profile definition of each VM, and can be based on several factors, such as the type of workload, performance requirements, service level agreements, and uptime. When a new VM is created, but sufficient resources (CPU, storage, memory, network) are not available to satisfy its profile definition to perform the live update, the required resources are donated from other VMs in the system, based on their priorities in their profile definitions, and added to the new VM. For example, if the VM having the lowest priority has extra resources, these are donated to the new VM up to a defined maximum that the VM can donate. If the new VM still cannot be created, the next lowest priority VM is checked for excess resources to donate. This continues until the resource requirement for the new VM is satisfied. Although one or more VMs may donate resources, there is a maximum that can be removed, as defined in the VM's profile definition, such that the donor VM continues to run. In systems not having a dynamic logical partitioning feature, the resource calculation and movement may be performed manually.

Upon completion of the live update, the original VM is deleted, and its resources are returned to the system. Any donated resources are returned to their respective VM donors.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

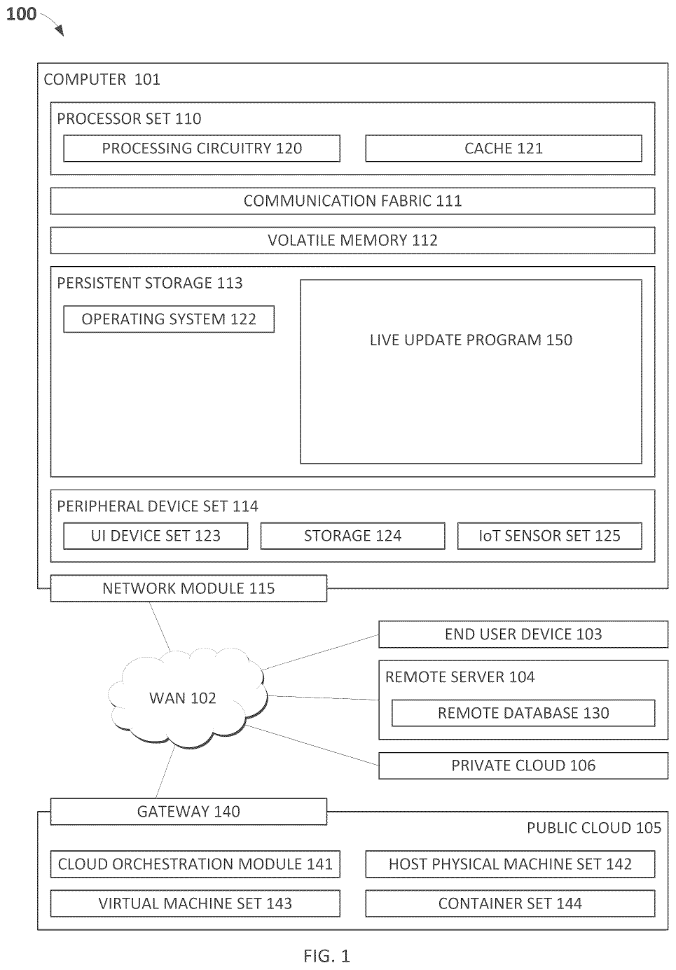

Referring to FIG. 1, a computing environment 100 according to at least one embodiment is depicted. Computing environment 100 contains an example of an environment for the execution of at least some of the computer code involved in performing the inventive methods, such as sustainable RAID storage program (program) 150. In addition to the program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, also referred to as the administrative computer or orchestrator, host physical machine set 142, virtual machine set 143, and container set 144. Furthermore, despite only being depicted in computer 101, the program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 is a schematic block diagram of an operating environment before and after a live update according to at least one embodiment. Although only two VMs are illustrated, an enterprise computer installation may include many more, all under the control of the administrative computer 141.

Here, the original VM 200 will be updated to become the new VM 201. The original root volume group 210 is cloned to become the root volume group clone 225. The desired software updates are applied to the root volume group clone 225, which is then mirrored to the new VM 201. The root volume group clone 225 on the new VM 201 is mirrored to become the root volume group clone mirror 220. The root volume group clone 225 becomes the boot device for the new VM 201. The software updates may also include updates to the original kernel 206, which will become the updated kernel 207 on the new VM 201. The administrative computer 141, also referred to as an orchestrator 141, directs the provisioning, validation, and operation of the live update process. The orchestrator 141 can be implemented on a separate workstation (as shown), or in another VM.

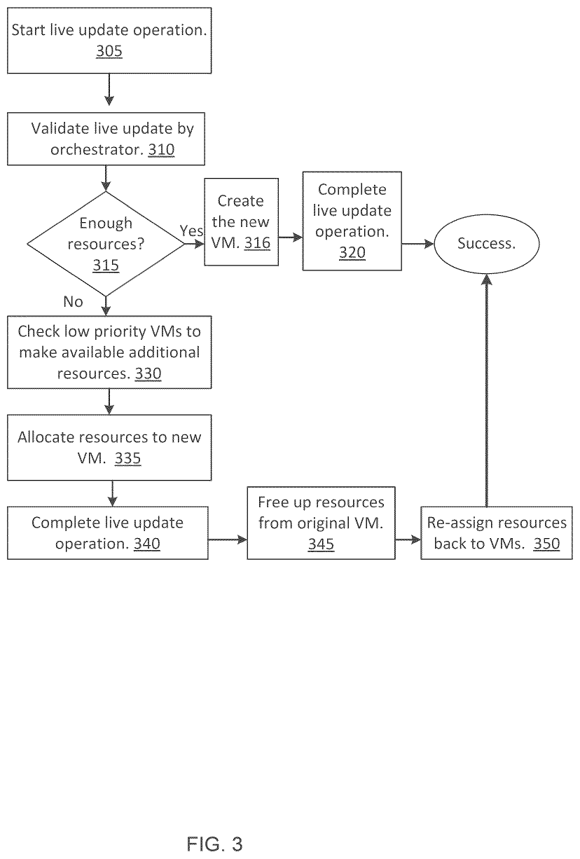

FIG. 3 is an operational flowchart illustrating a live update operation according to at least one embodiment.

The live update operation begins at 305. Any application procedures, such as checkpointing or backup, should be performed prior to migration. The orchestrator 141 verifies the contents of the profile definitions for each VM, particularly that the profile definition includes a valid assigned priority that can be specified as a numeric or other value such as low, medium, high or “1”, “2”, “3.”

At 310, the orchestrator 141 validates that the resources needed to create the new VM 201 for the live update are available. The memory and CPU resource required for the new VM 201 is equal to the amount of resources that the VM 200 is currently using. These resources are assigned to the new VM 201 temporarily for the duration of the live update, after which the resources are released. These resources can exist in a pool of unused resources by resource type, for example, a pool of unused CPU or a pool of unused memory.

If at 315 there are enough resources to create a new VM 201, then at 316 the orchestrator 141 communicates with the virtualization control program, for example, a hypervisor, to create the new VM 201. The root volume group 210 on the original VM 200 is cloned to become the root volume group clone 225. The root volume group clone 225 is updated with the desired software, and is mirrored to the new VM 201 as its root volume group clone 225. While the original VM 200 continues hosting the running workload 205, the new VM 201 is started using the root volume group clone 225 as the boot disk. This disk is then mirrored as the root volume group clone mirror 220 on the new VM 201. At this point, the workload 205 is migrated non-disruptively.

At 320, the live update operation completes. The original VM 200 is deleted, which releases its resources so that they are available to other VMs in the configuration.

If at 315 there are not enough resources to create a new VM 201, then at 330 the orchestrator 141 reduces the resources from other donor VMs, according to their priority as defined in their profile definitions, until the new VM 201 can be created. The running states of the donor VMs are not impacted.

At 335 the new VM 201 is created out of the resources from the donor VMs. As in 316, the shared disks are created, and the workload is non-disruptively migrated from the original VM 200 to the new VM 201.

At 340 the live update operation completes. As in 320, the original VM 200 is deleted, making its resources available for other configurations. Also, any resources taken from donor VMs (345) are returned to the donors in priority order, starting with the highest priority VMs (350).

It may be appreciated that FIGS. 2 and 3 provide only an illustration of one embodiment and do not imply any limitations regarding how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method to perform operating system live update in a resource constrained computer system, the computer-implemented method comprising:
verifying, by an orchestrator, that the contents of a profile definition of each VM includes a valid assigned priority;
verifying, by the orchestrator, that sufficient free resources are available in the computer system to create a new VM corresponding to an original VM;
based on there not being sufficient free resources, beginning with a donor VM having a lowest priority and continuing to the donor VM having a next higher priority, moving resources from the donor VM to the new VM until the new VM has resources corresponding to the original VM;
updating the software on a root volume group of the original VM;
exporting the root volume group of the original VM and assigning the exported root volume group as the root volume group of the new VM;
activating the new VM; and
following non-disruptive migrating of a workload from the original VM to the new VM, terminating the operating system live update.

2. The computer-implemented method of claim 1, wherein the terminating the operating system comprises:
deactivating and deleting the original VM;
returning to each donor VM the resources assigned to the new VM, according to a priority order; and
returning resources corresponding to the original VM to a pool of free resources.

3. The computer-implemented method of claim 1, wherein the resources include CPU, memory, I/O, and storage.

4. The computer-implemented method of claim 1, wherein the resources are selected from a pool of free resources.

5. The computer-implemented method of claim 1, wherein the profile definition defines a maximum amount of resources that the donor VM can donate such that the donor VM remains operating.

6. The computer-implemented method of claim 1, wherein a backup of the operating system and any application software is completed prior to initiating the live update.

7. The computer-implemented method of claim 1, wherein the priority is based on service level agreement, uptime, performance requirements, and workload.

8. A computer program product to perform operating system live update in a resource constrained computer system, wherein the computer program product comprises a computer readable storage medium having program instructions embodied therewith, the program instructions executable by a processing unit to cause the processing unit to perform a method comprising:
verifying, by an orchestrator, that the contents of a profile definition of each VM includes a valid assigned priority;
verifying, by the orchestrator, that sufficient free resources are available in the computer system to create a new VM corresponding to an original VM;
based on there not being sufficient free resources, beginning with a donor VM having a lowest priority and continuing to the donor VM having a next higher priority, moving resources from the donor VM to the new VM until the new VM has resources corresponding to the original VM;
updating the software on a root volume group of the original VM;
exporting the root volume group of the original VM and assigning the exported root volume group as the root volume group of the new VM;
activating the new VM; and
following non-disruptive migrating of a workload from the original VM to the new VM, terminating the operating system live update.

9. The computer program product of claim 8, wherein the terminating the operating system comprises:
deactivating and deleting the original VM;
returning to each donor VM the resources assigned to the new VM, according to a priority order; and
returning resources corresponding to the original VM to a pool of free resources.

10. The computer program product of claim 8, wherein a profile definition of each virtual machine includes a priority.

11. The computer program product of claim 8, wherein the resources include CPU, memory, I/O, and storage.

12. The computer program product of claim 8, wherein the resources are selected from a pool of free resources.

13. The computer program product of claim 8, wherein the profile definition defines a maximum amount of resources that the donor VM can donate such that the donor VM remains operating.

14. The computer program product of claim 8, wherein a backup of the operating system and any application software is completed prior to initiating the live update.

15. A computer system to perform operating system live update in a resource constrained computer system, the computer-implemented method comprising:
one or more processors;
a memory coupled to at least one of the processors;
a set of computer program instructions stored in the memory and executed by at least one of the processors to perform actions of:
verifying, by an orchestrator, that the contents of a profile definition of each VM includes a valid assigned priority;
verifying, by the orchestrator, that sufficient free resources are available in the computer system to create a new VM corresponding to an original VM;
based on there not being sufficient free resources, beginning with a donor VM having a lowest priority and continuing to the donor VM having a next higher priority, moving resources from the donor VM to the new VM until the new VM has resources corresponding to the original VM;
updating the software on a root volume group of the original VM;
exporting the root volume group of the original VM and assigning the exported root volume group as the root volume group of the new VM;
activating the new VM; and
following non-disruptive migrating of a workload from the original VM to the new VM, terminating the operating system live update.

16. The computer system of claim 15, wherein the terminating the operating system comprises:
deactivating and deleting the original VM;
returning to each donor VM the resources assigned to the new VM, according to a priority order; and
returning resources corresponding to the original VM to a pool of free resources.

17. The computer system of claim 15, wherein a profile definition of each virtual machine includes a priority.

18. The computer system of claim 15, wherein the resources include CPU, memory, I/O, and storage.

19. The computer system of claim 15, wherein the resources are selected from a pool of free resources.

20. The computer system of claim 15. wherein the priority is based on service level agreement, uptime, performance requirements, and workload.
